(19) United States
(12) Patent Application Publication
(10) Pub. No.: US 2006/0233485 A1
(43) Pub. Date: Oct. 19, 2006

(54) Underwater structure monitoring systems and methods

(76) Inventor: Donald Wayne Allen, Richmond, TX (US)

Correspondence Address: SHELL OIL COMPANY, P O BOX 2463, HOUSTON, TX, 772522463, US

(21) Appl. No.: 11/385,150

(22) Filed: Mar. 21, 2006

Related U.S. Application Data
(60) Provisional application No. 60/664,346, filed on Mar. 23, 2005.

(51) Int. Cl. G02B 6/00

(52) U.S. Cl. 385/13

(57) ABSTRACT

A system for remotely detecting properties of an underwater structure in a body of water comprising a sensor connectable to the structure; a first receiver which can be positioned at or near a top surface of the body of water in the proximity of the structure; a first transmitter for transmitting property information from the sensor to the first receiver; and a second transmitter for transmitting the property information to a second receiver which can be located at a remote location.

### CROSS-REFERENCE TO RELATED APPLICATION

This application claims priority to U.S. Provisional Application 60/664,346 filed on Mar. 23, 2005, herein incorporated by reference in its entirety.

### FIELD OF THE INVENTION

This invention relates generally to systems for detecting properties, such as stress, strain, or temperature, acting upon a structure. More specifically, this invention relates to a system for remote detecting properties of an underwater structure.

### BACKGROUND OF THE INVENTION

In some environments, it is necessary or desirable to monitor the location and magnitude of environmental factors, such as selected loads and/or temperatures acting upon a physical structure, typically by monitoring a plurality of force transducers or thermocouples mounted along the length of the structure. For example, it is highly desirable to locate and quantify localized stress and/or strain and/or temperatures to which an oil or gas pipeline is subjected, primarily as a result of variations in pipeline environment, such as underwater currents or vortex induced vibration, so that remedial measures may be taken prior to breakage of the pipeline.

One way of monitoring structural performance is to measure the strain response to load. Strain may be compared to design predictions and monitoring the change in strain during service may be an indicator of structural degradation due to overload, impact, environmental degradation or other factors.

Forces and/or temperature acting upon an underwater structure may be locally monitored with a direct connection between a force detector and the monitor. As the number of locations which need to be monitored increase, there needs to be an increase in the number of local monitors to determine the level of force and/or temperature acting at each of the locations. Accordingly there is a need in the art to provide a practical and effective system for remotely monitoring properties of an underwater structure.

### SUMMARY OF THE INVENTION

One aspect of the invention provides a system for remotely detecting properties of an underwater structure in a body of water comprising a sensor connectable to the structure; a first receiver which can be positioned at or near a top surface of the body of water in the proximity of the structure; a first transmitter for transmitting property information from the sensor to the first receiver; and a second transmitter for transmitting the property information to a second receiver which can be located at a remote location.

Another aspect of the invention provides a method of remotely detecting properties of an underwater structure comprising collecting property information at a sensor connected to the structure; transmitting the information from the sensor to a first receiver at or near a top surface of a body of water; and transmitting the information from the first receiver to a second receiver positioned at a remote location.

### BRIEF DESCRIPTION OF THE FIGURES

FIG. 1 illustrates a system for remotely detecting properties of an underwater structure.

FIG. 2 illustrates a system for remotely detecting properties of an underwater structure.

FIG. 3 illustrates a system for remotely detecting properties of an underwater structure.

FIG. 4 illustrates a connector assembly.

FIG. 5 illustrates a system for remotely detecting properties of an underwater structure.

FIG. 6 illustrates a system for remotely detecting properties of an underwater structure.

FIG. 7 illustrates a cross-sectional view of a cable.

### DETAILED DESCRIPTION OF THE INVENTION

In one embodiment, there is disclosed a system for remotely detecting properties of an underwater structure in a body of water comprising a sensor connectable to the structure; a first receiver which can be positioned at or near a top surface of the body of water in the proximity of the structure; a first transmitter for transmitting property information from the sensor to the first receiver; and a second transmitter for transmitting the property information to a second receiver which can be located at a remote location. In some embodiments, the sensor comprises a fiber optic cable. In some embodiments, the system also includes an umbilical which can connect the first transmitter and/or the sensor to the first receiver. In some embodiments, the first receiver can be positioned on a floating object, for example a buoy or a boat. In some embodiments, the second transmitter comprises a device adapted to transmit a signal in the electromagnetic spectrum, such as a radio frequency transmitter and an antenna; a large visible display which can be read from the remote location; a light source which can be modulated, such as to transmit morse code; a microwave transmitter; and a laser modulation device. In some embodiments, the sensor comprises a fiber optic cable and a plurality of bragg gratings. In some embodiments, the sensor comprises a fiber optic cable and plurality of microbend transducers. In some embodiments, the underwater structure comprises a pipeline, a piling, or a foundation. In some embodiments, the remote location comprises an offshore platform. In some embodiments, the sensor comprises a fiber optic cable, the fiber optic cable being connectable to a light source, a light receptor, and a processor for processing the information. In some embodiments, the sensor comprises a first fiber optic cable attachable to the structure; a second fiber optic cable capable of acting as a reference; a light source which can be placed at a first end of the first fiber optic cable and at a first end of the second fiber optic cable; a light receptor which can be placed at a second end of the first fiber optic cable and at a second end of the second fiber optic cable; and a comparator for comparing the light signals which can be received from the first and second fiber optic cables.

In one embodiment, there is disclosed a method of remotely detecting properties of an underwater structure comprising collecting property information at a sensor connected to the structure; transmitting the information from the sensor to a first receiver at or near a top surface of a body of water; and transmitting the information from the first receiver to a second receiver positioned at a remote location. In some embodiments, the sensor comprises a fiber optic cable. In some embodiments, transmitting the information from the sensor to the first receiver comprises transmitting by an umbilical. In some embodiments, the sensor is connected to the structure before the structure is installed underwater. In some embodiments, transmitting the information from the first receiver to the remote location comprises feeding the information to a radio frequency transmitter located at or near a top surface of a body of water, which radio frequency transmitter broadcasts the information with an antenna. In some embodiments, collecting property information at the sensor comprises bending a fiber optic cable with a plurality of bragg gratings, and measuring a response to the bending. In some embodiments, collecting property information at the sensor comprises measuring the output from a plurality of microbend transducers. In some embodiments, the sensor comprises a fiber optic cable, a light source, a light receptor, and a processor, the method further comprising sending a light signal into the fiber optic cable from the light source; receiving a modified light signal from the fiber optic cable to the light receptor; and processing the modified light signal with the processor. In some embodiments, the sensor comprises a first fiber optic cable attached to the structure and a second fiber optic cable acting as a reference, a light receptor, a processor, and a comparator, the method further comprising sending light signals into the first and second fiber optic cables at a first end of the first fiber optic cable and a first end of the second fiber optic cable; receiving the modified light signals from the first and second fiber optic cables at the light receptor at a second end of the first fiber optic cables and at a second end of the second fiber optic cables; processing the modified light signals with a processor; and comparing the modified light signals received from the first and second fiber optic cables with a comparator.

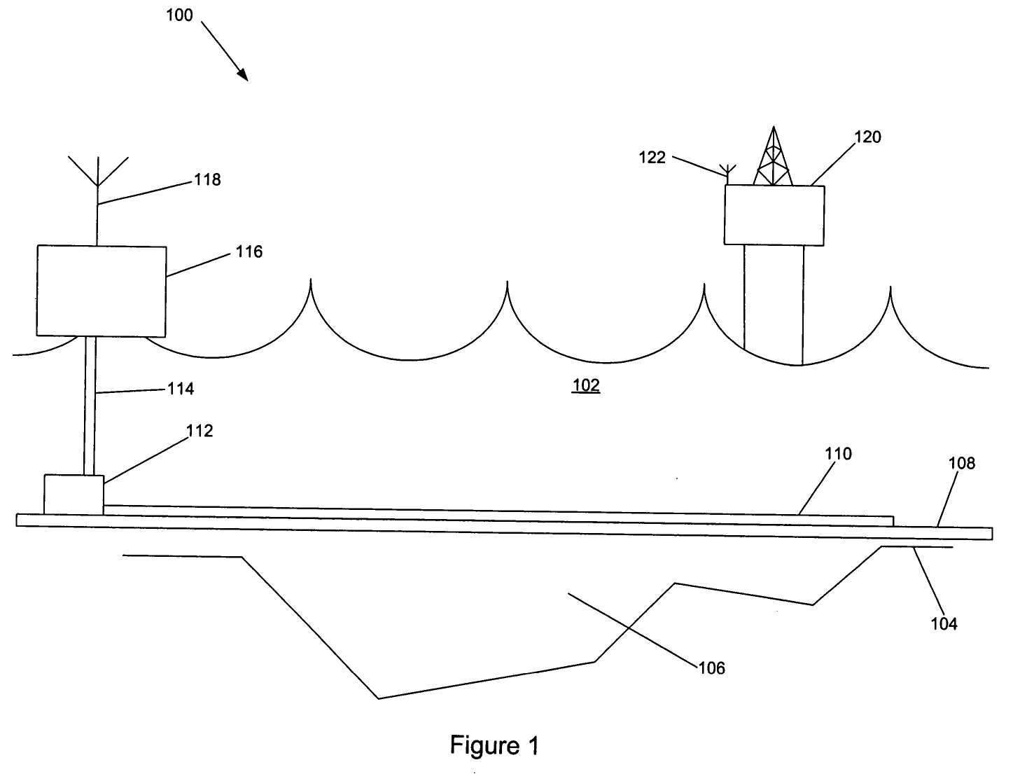

Referring now to FIG. 1, in one embodiment of the invention, there is illustrated system 100 for remote detecting properties of a structure. System 100 includes a body of water 102 with a bottom 104, which includes a channel portion 106. Underwater structure 108, for example a pipeline or a foundation, runs along the bottom 104 and crosses channel 106. Portions of the body of water 102 are above structure 108 and below structure 108 within channel 106. Sensor 110, for example a fiber optic cable, accelerometers, or thermocouples, is connected to structure 108 in the area of the structure 108 crossing the channel 106. Sensor 110 is attached to connector 112. First transmitter 114, for example an umbilical or fiber optic cable, is attached to connector 112 and first receiver 116, which may be located on a floating object, for example a buoy or a boat. First receiver 116 may be connected to second transmitter 118, for example an RF transmitter connected to an antenna or satellite dish, which transmits information on the properties of structure 108 collected by sensor 110 to platform 120, which has receiver 122, for example an antenna or satellite dish, to receive the information.

In some embodiments of the invention, sensor 110 is a fiber optic cable, and connector 112 includes a light source for transmitting light into fiber optic cable 110, and a receptor for collecting and analyzing reflections from fiber optic cable 110.

In some embodiments of the invention, sensor 110 and first transmitter 114 are a fiber optic cable, and first receiver 116 includes a light source and a light receptor for passing and receiving a light source through first transmitter 114 and fiber optic cable 1 10, in order to analyze properties of structure 108.

In some embodiments of the invention, connector 112 and first transmitter 114 include a mechanism for wireless transmission of strain information to first receiver 116, for example acoustic transmission such as telemetry through body of water 102.

In some embodiments of the invention, first receiver 116 and second transmitter 118 are adapted to transmit information to another receiver and/or antenna on shore.

In some embodiments of the invention, first receiver 116 includes a light source and a light receptor for transmitting a light signal through first transmitter 114 and sensor 110, which may be separate fiber optic cables, or a single fiber optic cable fed through connector 112.

In some embodiments of the invention, measurement system 100 incorporates optical glass fibers or large strain plastic optical fibers 110 integrally attached to the outside of a metal or composite structure 108 using a bonding agent such as epoxy or a bracket or clamp, and protected from the environment including sea water and service damage by the bonding agent and optionally, an additional layer of polymer or rubber-like material.

In some embodiments of the invention, axial strains may be measured using an Optical Time Domain Reflectrometry (OTDR) fiber optics method by placing optical fibers 110 along the axis of structure 108 starting at one end and traversing to the other end, and if needed, to provide greater strain resolution; to loop the optical fiber 110 back and forth as many times as needed to amplify the displacement magnitude.

In some embodiments of the invention, a method using the Optical Time Domain Reflectrometry (OTDR) fiber optics is provided to measure average strains in a metal or composite tubular structure 108 including measurement of average circumferential strains as well as average axial strains over a long length of the structure 108 including from end to end.

In some embodiments of the invention, a Bragg Diffraction Grating fiber optics method is used to measure local strains in a structure 108 in any direction, either circumferential or axial or at any angle to the axis of the tube, determined by design or test to be critical.

In some embodiments of the invention, system 100 is provided to determine strain concentrations and local anomalies by measuring average strains, either circumferential or axial or at any angle to the axis of the structure 108 using the Optical Time Domain Reflectormetry (OTDR) optical fiber strain measurement method. In some embodiments of the invention, the optical fiber 110 is attached to the structure 108 using a bonding agent such as epoxy or a clamp, and to protect the optical fiber 110 by the bonding agent and with an additional outside protective layer of polymer or rubber-like material.

In some embodiments of the invention, there may be provided a continuous optical fiber path to the surface, for example to a processor on a floating object which also includes first receiver 116. In some embodiments of the invention, a processor may be located at connector 112, and a hard wire 114 or remote telemetry may be used to transfer the optical signal to the surface, for example to first receiver 116. First receiver 116 and second transmitter 118 may be used to relay and amplify the signal, for example to platform 120, with an antenna 122.

In some embodiments of the invention, fiber optic sensors with Bragg gratings may be used. System 100 may include an optical fiber 110 wound along a helical line on the pipe 108. The optical fiber 110 may be provided with a number of sensors, for example Bragg gratings or transducers, adapted to reflect light with different wavelengths. A light source in connector 112 emits light with a large range of wavelengths into the fiber 110. As the different Bragg gratings reflect light, for example back to connector 112, with different wavelengths, strain induced changes in the different gratings will indicate the amplitude and the position of the provided strain as changes in the spectrum of the reflected light.

In some embodiments of the invention, a large number of strain monitors, for example microbend transducers or accelerometers, may be monitored from a single monitoring station. The length of the structure 108 which may be monitored may be a function of the quality of the optical fiber 110, the number of transducers installed along the fiber, and the intensity of the light signal. In some embodiments of the invention, a plurality of parallel optical fibers are provided along the structure 108. The plurality of fibers may be monitored simultaneously or in sequence with a single optical time domain reflectometer by switching the pulsed light signal from one fiber to another and by reflecting the back- scattered light from all of the fibers to a photodetector.

In some embodiments of the invention, suitable strain monitors include microbend transducers, for example such as disclosed in U.S. Pat. No. 4,477,725, herein incorporated by reference in its entirety. In some embodiments of the invention, microbend transducers may operate by moving a flexible beam attached to the structure 108 in response to the presence of the force acting upon the structure relative to a rigid beam that does not move. When this force moves the flexible beam toward the rigid beam, transducer blocks may be moved toward or away from each other to engage and bend optical fiber 110. Such bending, or microbending, causes localized attenuation of transmitted and backscattered light, wherein a portion of the light may be scattered from a fiber core to a fiber cladding. The attenuation of backscattered light may be located and quantified by a photodetector or an optical time domain reflectometer.

In some embodiments of the invention, optical fiber 110 includes a transparent core of a suitable glass or plastic material which may be carried within a relatively thin cylindrical cladding having an index of refraction less than the refractive index of the core. When a light signal such as a collimated beam generated by a laser 112 is focused upon one end of the fiber, the fiber core functions as a waveguide to transmit or propagate the light signal through the core with relatively small internal intensity losses or transmission of the signal to the cladding. Gradual turns or bends in the fiber 110 may have little or no effect upon transmission of the light signal, thereby permitting transmission of the light signal through the fiber 110 for emission at the opposite end of the fiber regardless of the number of bends and turns. Relatively short bends in optical fiber 110 may have a significant effect upon the transmissivity of the fiber core. The presence of a short bend having a period on the order of a few millimeters, commonly referred to as a microbend, may result in an attenuation of the propagated light signal which arises by scattering of a portion of the signal from the fiber core to the cladding from where most of the scattered light portion is lost ultimately to the surrounding environment.

In some embodiments, the concept of optical fiber 110 microbending may be used as a transducer mechanism for sensing and quantifying force acting upon physical structure 108. In this type of application, a microbend transducer is mounted on the structure 108 for movement therewith in response to force to induce microbending of optical fiber 110. The microbending causes a detectable attenuation of a light signal passing through the fiber 110, wherein the degree of attenuation is indicative of the magnitude of force.

In some embodiments, optical fiber 110 may be used to provide a reliable in situ method to measure not only peak strain values but also the dynamic response imposed during loading, for example due to strong ocean currents, such as loop currents or mooring line tension. Optical fiber 110 may also be used to measure temperature, which may be of interest to exploration and production operations. Suitable fiber optics technology includes Optical Time Domain Reflectrometry (OTDR) and Bragg defraction grating methods, for in situ measurement of strain and/or temperature. Bragg gratings may be used for making local strain and/or temperature measurements, while the Optical Time Domain Reflectrometry method may be used for making global strain measurements such as the average strain over the length of a structure. An OTDR may measure spatial positions along an optical fiber by launching brief pulses of light into one end of the fiber and then detecting the subsequent reflections at physical interfaces inserted along the length of the fiber. By measuring the transit time of the reflected pulses and by knowing the speed at which light travels in the optical fiber, a very accurate measure of the distance to each reflective interface may be attained. If a gauge section undergoes a strain, hence changes the interface's spatial position along the fiber, measurement of the change of length is a direct measurement of the average strain in the component. A single optical fiber may be used to measure strains at more than one location by imposing additional reflective surfaces along the length of the optical fiber in combination with customized software algorithms to measure strain between each adjacent reflective interface. Measurement of the longitudinal strain in a structure tube provides valuable information about the state of the “fitness for service” of the structure when compared to design allowables and expected conditions. Vortex-induced dynamic motions may be imposed by ocean currents on underwater structures. Both the OTDR and Bragg Defraction Grating techniques may be used to measure the bending strains imposed by VIV on offshore marine structures. By placing one or more optical fiber sensors at different locations, for example at diametrically opposite sides of the tube or offset by an angle from 90 to 270 degrees, one may determine the strains due to bending which occur during the dynamic vibration imposed by the ocean currents, for example VIV. Since the direction of bending is not known, several optical fibers may be introduced onto the tube to be assured of obtaining the maximum bending effect.

In some embodiments of the invention, a mode stripper is provided with optical fiber 110, for example at a location of a microbend or grating, to strip the portion of the light scattered to the fiber cladding and thereby prevent reflection of this light back to the fiber core. This mode stripper may be a substance having a generally irregular external configuration and an index of refraction generally matched with or greater than the index of refraction of the fiber cladding such that the light propagated in the cladding is transmitted to the stripper substance where it is ultimately lost. Alternately, the mode stripper may be provided in the form of an optically black surface coating disposed directly on the fiber 110, for example at the microbend or grating, to absorb the portion of the light scattered to the fiber cladding.

In some embodiments of the invention, it is further desirable to prevent bending of the optical fiber 110 beyond a selected amplitude to prevent excess stress on the fiber and to prevent excess attenuation which might obscure detection of microbending induced by other transducers along the length of the fiber. This control may be provided by one or more stops.

In some embodiments of the invention, multiple transducers may be installed in a closely spaced cascaded relation on a structure 108 wherein the cascaded transducers are adapted for response to pipeline movement in different directions. If desired, position indicators, such as fiber couplings which create reflection spikes for detection by the photodetector, may be interposed between selected transducers to permit precise identification of the particular transducer responding to pipeline movement.

In some embodiments of the invention, system 100 includes first receiver 116 including a computer and an optical black box 112 located on the sea floor, and a multi-strand optical cable 1 10 that extends down the length of the structure. A plurality of sensors may be connected to the optical cable 110 to record the strains in the structure 108, which are relayed to the optical black box 112 and computer in real time. The magnitude and direction of the principle strain and the number of stress-strain cycles may be counted and accumulated as total fatigue. The accumulated fatigue may be compared to known SN curves of established metals to produce a percentage of used fatigued life. The computer may be an off-the-shelf personal computer (PC) or DAQ-type (data acquisition) workstation depending on the amount of data interpretation, manipulation or storage required. The optical black box 112 may be purpose built, purchased, or obtainable from companies like Astro Technology, a Houston, Tex., USA-based specialist in fiber-optics technology. It may provide the light source, interrogate the signal to understand the changes in frequency that may be related back to minute changes in the optical fibers (and strain gauges), and may compensate for known effects on the signals caused by temperature effects. The multi-strand optical cable 110 may be assembled from fiber optics strand components and ruggedized and armored obtainable from cable companies like McArtney in Houston, Tex., USA, such that it is protected for the intended environment in practical diameters of about 1 to 2 cm, and lengths of about 10 to about 5000 meters as the particular location requires.

In some embodiments of the invention, first transmitter 114 may supply power to connector 112 and sensor 110. In some embodiments of the invention, there may be provided multiple umbilicals, connectors, and strain monitors attached to a single first receiver 116. In some embodiments of the invention, connector 112 and sensor 110 may have a local power source, for example a battery or a power cable, or be connected to an underwater power generating device.

In some embodiments of the invention, a floating object housing first receiver 116 may be connected to moorings, for example steel cables or polyester ropes. In some embodiments of the invention, buoy moorings may be connected to bottom 104 or anchored to a structure or structure 108.

In some embodiments of the invention, first receiver 116 may include hydrophones for listening to signals from connector 112, batteries or a generator for supplying power, and/or transmitters for sending signals to platform 120 and/or to the beach.

Transmitters may be any commercially available RF (radio frequency) transmitter capable of transmitting a data signal at least about 5 km, for example about 10 to 50 km.

In some embodiments of the invention, first receiver 116 may include a reservoir of a hydrate inhibitor and an umbilical to inject the inhibitor into structure 108.

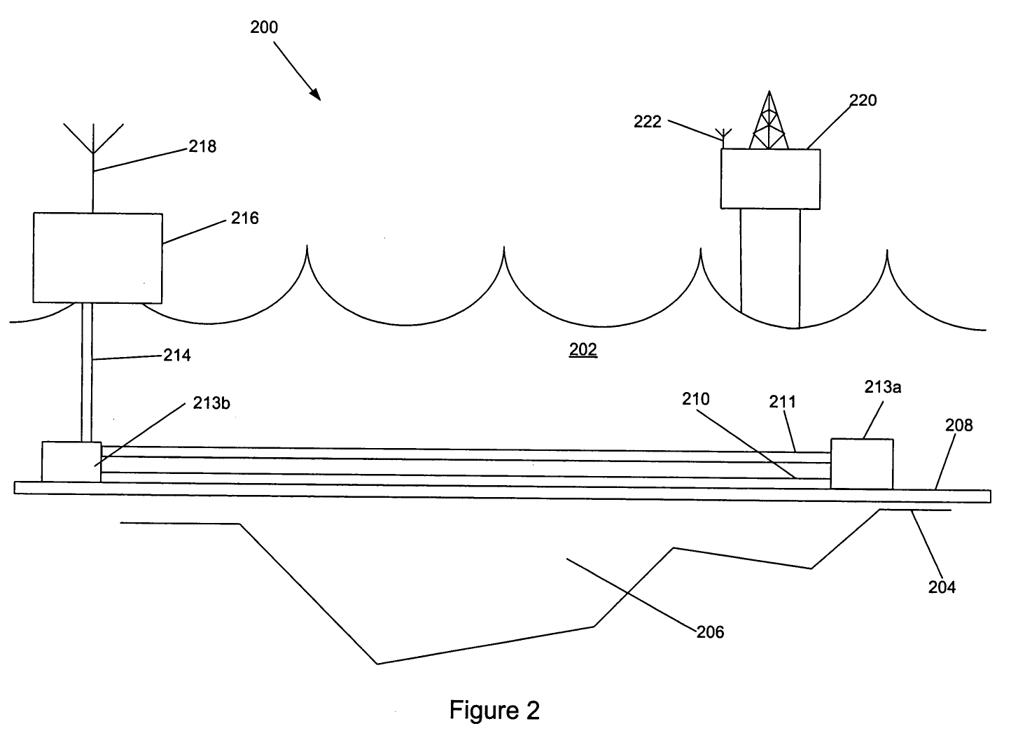

Referring now to FIG. 2, in some embodiments of the invention, system 200 is illustrated. System 200 includes a body of water 202 having a bottom 204, defining a channel 206. Structure 208 runs across channel 206. Sensor 210 is connected to structure 208 in the area of channel 206, and reference monitor 211 also runs adjacent sensor 210. Sensor 210 and reference 211 are connected at first end to connector 213A and at second end to connector 213B. Umbilical 214 is connected to connector 213B and buoy 216. Buoy 216 includes antenna 218 for transmitting strain information regarding structure 208 to antenna 222 on remote platform 220.

In some embodiments of the invention, connector 213A may include a light source for transmitting light into sensor 210 and reference 211, and connector 213B may include a light receptor for receiving light signal from sensor 210 and reference 211, and a comparator for comparing the light signals to determine strain on structure 208.

In some embodiments of the invention, one or more of sensor 210, reference 211, and/or umbilical 214 are fiber optic cables.

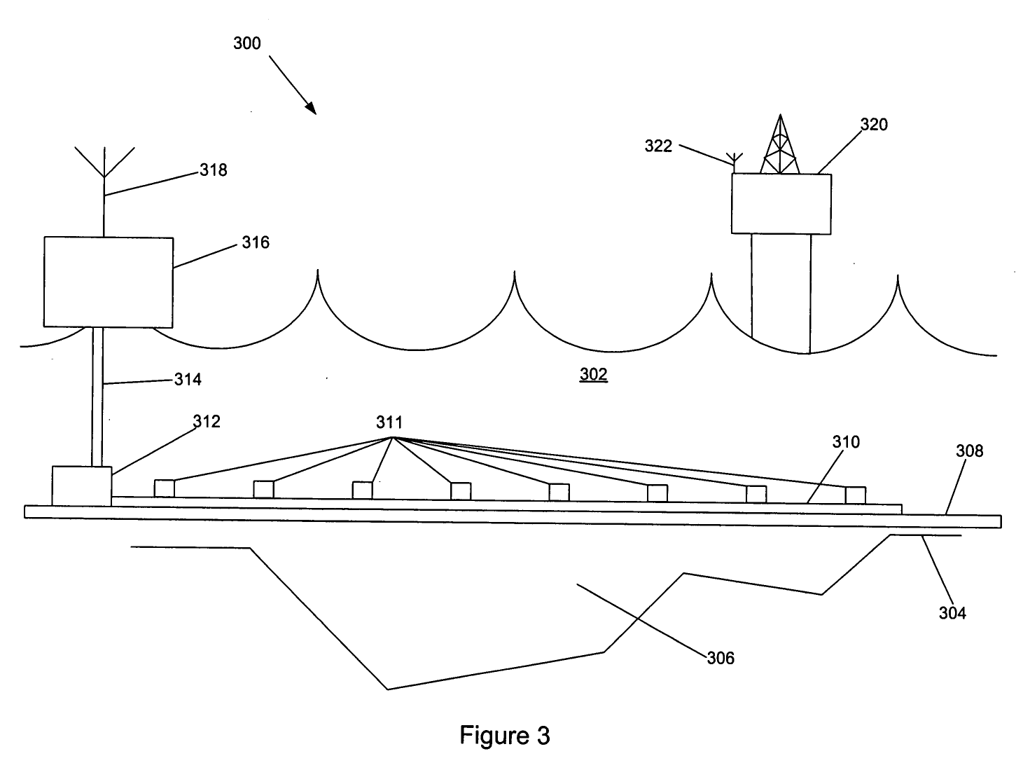

Referring now to FIG. 3, in some embodiments of the invention, system 300 for monitoring properties of a structure is illustrated. System 300 includes body of water 302 having bottom 304 with a channel 306. Structure 308 crosses channel 306. Cable 310 is connected to structure 308, and sensors 311 are provided along the length of cable 310. Output from sensors 311 is fed through cable 310 to connector 312. Umbilical 314 is connected to connector 312 and buoy 316, which has antenna 318. Information of structure 308 is passed from antenna 318 to antenna 322 on remote platform 320.

In some embodiments of the invention, sensors 311 may be Bragg Gratings, connected to a fiber optic cable 310.

In some embodiments of the invention, sensors 311 may be accelerometers. In some embodiments of the invention, sensors 311 may be thermocouples and/or thermometers.

In some embodiments of the invention, sensors 311 may be microbend transducers connected to optical fiber 310.

In some embodiments of the invention, there are about 10 to 25 sensors 311 per optical fiber 310. Each sensor 311 may measure the direction of the strain, either circumferentially and/or longitudinally, and the magnitude of the strain, for the structure 308 in tension and/or in compression. A suitable spacing between each of the sensors 311 may be about 2 to 100 meters.

In some embodiments of the invention, sensors 311 may be installed to an existing structure 308 using an instrumented curved plate that is attached to the structure 308 with sub-sea epoxy. The plates may be placed along the length of the structure 308 manually, or using an underwater ROV (remotely operated vehicle). The curved plate would be of a compatible material, such as corrosion-resistant steel or aluminum, spaced out at distances such as about 3 to 15 meters.

In some embodiments of the invention, the sensors 311 may be installed sub-sea using a “piggyback” concept. The piggyback concept uses clamps, instrumented with sensors 311, which are fastened to the existing structure 308. The clamp provides sufficient compressive force to act as a composite section with the structure 308. With this method, the sensors 311 on the clamp may monitor the strains experienced by the clamps. The strains on the clamps are recorded, allowing the amplitude and the number of stress-strain cycles of the structure 308 to be calculated. The amplitude and the number of stress-strains cycles, together with the SN (stress vs. number of cycles to failure) curve of the structure 308, allow the fatigue and remaining life of the structure 308 to be calculated. In general, the fatigue assessment may track the number (“N”-axis in the SN-curve) of stress ranges (“S” axis in the SN-curve) over a period of time to determine the accumulation of damage or “fatigue.” SN-curves may be experimentally determined fatigue failure relationships between stress range and cycle numbers. There are numerous types of SN curves that may be a function of the material (type of steel) or detail (like the pipe wall or the weld location).

In some embodiments of the invention, a problem of underwater structures 308 is vortex-induced vibration (VIV). One way to reduce VIV is to increase the inherent damping of the structure. Compliant bushings may be included at the interface between joints of pipe. Helical strakes, fairings, or various shroud arrangements or other vortex suppression devices may be installed about the structure 308. Vortex suppression devices may be used in conjunction with optical fiber 310, where a channel or groove for the optical fiber may be provided under the helical strakes or under the fairings.

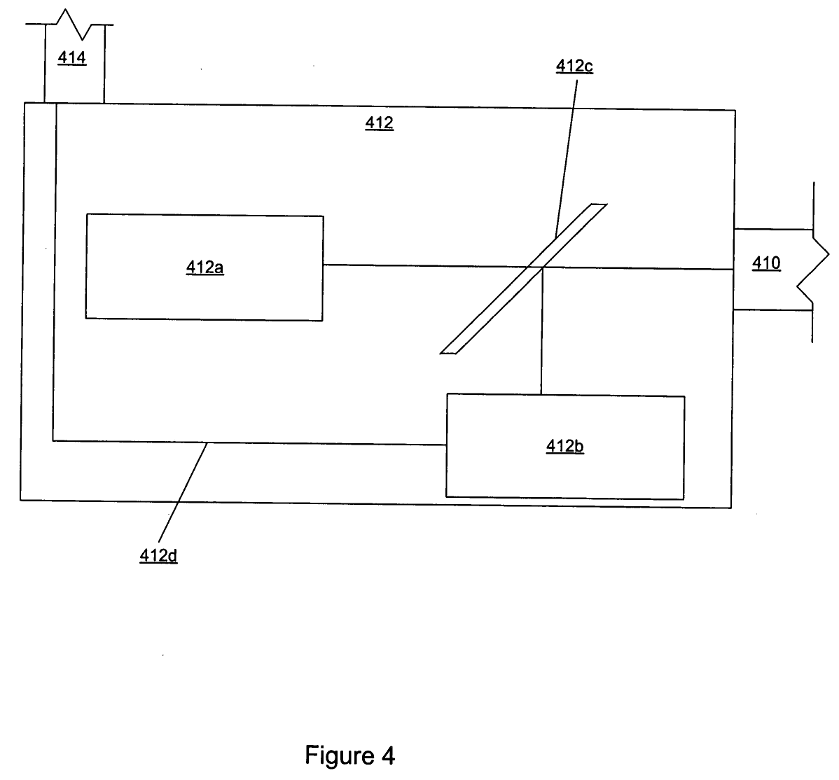

Referring now to FIG. 4, in some embodiments of the invention, connector 412 is illustrated. Connector 412 includes light source 412A, light receptor 412B, one-way mirror 412C, and connector 412D. In operation, light source 412A passes a light beam through mirror 412C into fiber optic cable 410. Reflections from fiber optic cable 410 are received into connector 412 and reflected by mirror 412C to light receptor 412B. Light receptor 412B then passes results by connection 412D to umbilical 414.

In some embodiments of the invention, light source 412A produces a pulsed light, for example at a constant interval, such as a pulsed laser or a strobe light.

In some embodiments of the invention, light source 412A produces a constant stream of light, for example a laser or a lightbulb.

In some embodiments of the invention, light receptor 412B includes a mechanism for decoding received light beam and producing information which may be passed to connector 412D.

In some embodiments of the invention, light receptor 412B is connected to fiber optic cable 412D and fiber optic cable 414 for passing received light from optical fiber 410 directly to umbilical 414.

In some embodiments of the invention, an optical time domain reflectometer (OTDR) 412 includes a light source 412a for launching a pulsed light signal through the fiber 410, and a photodetector 412b for detecting the intensity of backscattered light reflected back through the fiber 410 as a function of time to provide an indication of backscattered light intensity for each point along the length of the fiber 410.

In some embodiments of the invention, one or more microbends and/or Bragg gratings may be provided in the fiber 410 causing a portion of the transmitted and backscattered light to be lost and/or reflcted from the fiber 410 at each microbend and/or grating. This attenuation and/or reflection in backscattered light intensity at each microbend and/or grating may be sensed by the photodetector 412b which indicates the location and magnitude of the change, thereby identifying the location and magnitude of the force acting upon the structure.

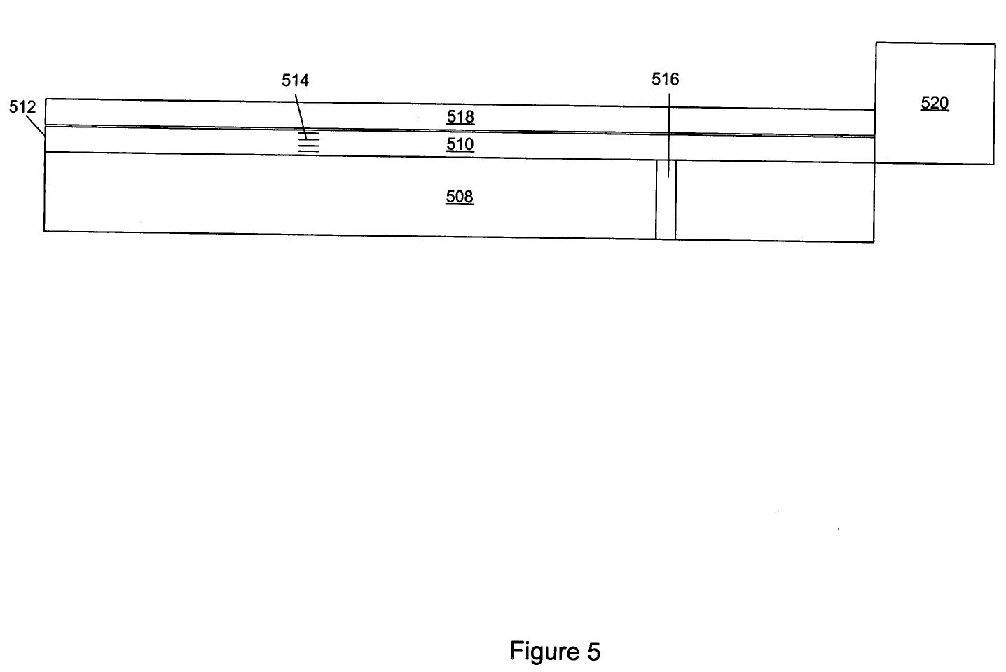

Now referring to FIG. 5, which is a side view of a metal or composite Tube 508 indicating the positioning of fiber optics apparatus 510 used to provide strain and/or temperature measurements. Axial optical fiber 510 is positioned along the axis of the metal or composite tube 508, where the glass or plastic optical fiber 510 may be etched to provide capabilities consistent with either optical time domain reflectrometry or bragg diffraction grating measurements. The optical time domain reflectometry optical fiber 510 may have a reflective interface 512 at the end of the fiber making possible a gage length of the entire length of the metal or composite tube 508. The bragg diffraction grating 514 is a localized grating on the order of about 1 to 10 cm in length and thus provides measurements of local strain. Circumferential optical fiber 516 is located to provide strain data about the circumferential or off-axis directions relative to the axial orientation of the tube 508. As with axially oriented optical fiber 510, strain measurements may be made using either Optical Time Domain Reflectrometry or Bragg Diffraction Grating techniques and optical fiber etchings.

The optical fibers 510, 516 may be placed onto the outside of a metal or composite Tube 508 following the tube structural fabrication. The optical fibers 510, 516 may be bonded using an adhesive such as epoxy directly to the tube 508 and a protective outer layer and fluid barrier 518 may be laid over the optical fibers 510, 516 to further protect them from impact and the environment. Similar protection may be provided in the transition of optical fibers 510, 516 into the fiber optics connection box 520, for example by overlaying the optical fibers with a polymeric or elastomeric material.

A metal or composite tube 508 may be connected to adjacent tubes using a threaded end connection, a weld, or another suitable connection method. In near proximity to one end is located a fiber optics connection box 520 which serves as the termination point for optical fibers and/or serves as the connection junction for transferring optical signals from one tube to the next tube and eventually to the surface and into a processor, for example an Optical Time Domain Reflectrometry or Bragg Diffraction Grating instrument which is used to process the data. In some embodiments of the invention, a processor is located in connection box 520, for example an Optical Time Domain Instrument or Bragg Diffraction Grating instrument, which processor then digitizes the data and sends it to surface, for example with electronic telemetry or hard wire.

Glass or polymeric optical fibers 510 may be positioned at selected locations on the outside surface of the metal or composite tube 508 structure. Generally, glass fibers have lower attenuation than polymeric fibers, and may be used for measuring small strains (less than approximately 1-percent), while plastic optical fibers such as polymethyl methacrylate or perfluorocarbon, which have strain capabilities exceeding 5-percent and relatively low attenuation for a polymeric optical fiber, may be used for larger strain measurements.

The axial strain in the body of the pipe 508 may be measured in a discrete local region using Bragg Diffraction Gratings 514, while the average strain over a longer section of the tube 508 may be measured using an Optical Time Domain Reflectrometry (OTDR) strain measurement method. The OTDR method measures the time of flight for light reflected from reflective interfaces placed at selected locations along the length of the optical fiber 510 and thus directly measures, through calibration, the change in the length between the two interfaces. These light reflection interfaces may be placed to provide strain measurements of short as well as long gage lengths. In some embodiments of the invention, the reflective interfaces could be placed at the each end of optical fiber 510 positioned from one end to the other end of tube 508 and thus provide a strain measurement of the average strain over the entire length of the tube 508. In some embodiments of the invention, if greater accuracy is needed, the optical fiber 510 could traverse back and forth from end to end of the tube 508 as many times as needed to provide a longer gage length.

Bragg Diffraction Gratings 514 may be etched into an optical fiber 510, which may be used to measure local strain anomalies at selected locations along the length of the tube 508. A single optical fiber 510 may have several diffraction gratings 514 etched on it, for example from about 0 to 20, or about 2 to 5. As is known in the art, the data acquisition system may individually interrogate each grating 514 and thus provide multiple local strain measurements using the same optical fiber 510.

In some embodiments of the invention, light will be reflected from Bragg gratings 514, and the reflected light is fed through the fiber 510 toward connector 520, which measures the spectrum of the reflected signal. The wavelength of these reflections is uniquely given by the period of the grating 514 and thus the strain from the structure 508 adjacent to each Bragg grating 514. The effect of the strain on the Bragg grating may be determined beforehand by calibration. This way each Bragg grating 514 will function as a strain sensor. If the reflection without external stimulation of the sensors or Bragg gratings 514 is known, changes in

the reflection may be used to detect strain changes in the gratings 514 and/or structure 508.

In some embodiments of the invention, Bragg gratings 514 may be provided with different reflection characteristics, for example given by different grating constants, so that each change may indicate in which sensor and thus which position along structure 508 the change has been.

In some embodiments of the invention, the emitted signal from connector 520 may be pulsed, so that the time of arrival for the received pulse may indicate the position along structure 508. This may require some filtering of unwanted signals as there may occur some reflections between the Bragg gratings 514.

In some embodiments of the invention, fiber end 512 may be provided with means to avoid reflections back to the connector 520. In other embodiments of the invention, since the distance to the end 512 may be well defined, this reflection, if the emitted signal is pulsed, may be removed in the detector system.

In some embodiments of the invention, a number of optical fibers may be used in which each comprises one or more sensors. These fibers and/or sensors may be longitudinally overlapped.

In some embodiments of the invention, suitable methods to make Bragg gratings 514 in an optical fiber 510 include diffusion, use of laser, and others as are known in the art.

In some embodiments of the invention, Fiber Bragg Grating (FBG) sensors 514 record strains at specific points in the optical fiber 510. Small grooves may be cut on the surface of the fiber 510 that make a sensor that is about 1 to 5 cm in length. When a strain is applied to the sensor 514, the frequency of light passing through the sensor is shifted. The shift in frequency is proportional to the applied strain, the light may be interrogated, and the strain on the sensor 514 calculated. Each sensor may be sensitive to a particular frequency band. Multiplexing assigns sensors different frequencies allowing several sensors to be placed on each fiber. Using multiplexing and multiple optical fibers, hundreds of sensors may be used in each system to record near continuous strain measurement along the structure 508.

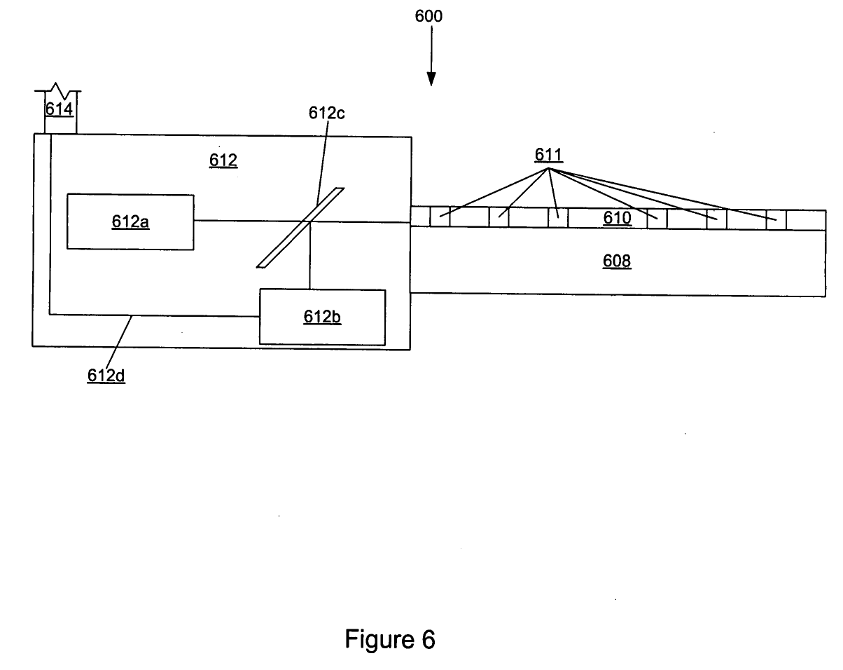

Referring now to FIG. 6, in some embodiments of the invention, an optical fiber system 600 is illustrated for use in detecting, locating, and quantifying forces acting along the length of an elongated structure 608. The system 600 is illustrated particularly for use in monitoring forces such as structural stresses acting along the length of an oil or gas pipeline, although the system 600 may be adapted for monitoring other types of forces and other types of structures. As shown, the optical fiber system 600 includes a plurality of strain monitors 611, for example microbend transducers and/or Bragg gratings, mounted at discrete, longitudinally spaced positions along the length of the structure 608 in a manner to induce a change of an optical fiber 610 in response to the presence of localized stress and/or strain acting upon the pipeline 608. This change of the fiber 610 results in an attenuation and/or reflection of light guided through the fiber 610 wherein the light change at one or more of the monitors 611 is located and quantified simultaneously by a processor 612b, for example an optical time domain reflectometer (OTDR) or a computer positioned at a convenient monitoring station 612.

In some embodiments of the invention, optical fiber system 600 may be used for remote measurement of forces such as stress at a number of discrete positions along the length of the pipeline 608. Localized forces to which pipeline 608 is subjected may be monitored, such as structural stress acting upon the pipeline resulting primarily from a combination of changing environmental conditions and/or gradual shifts in elevation, so that appropriate remedial action may be taken to relieve the stress prior to risking breakage of the pipeline. This type of monitoring system may be used with pipelines traveling through remote areas.

In some embodiments of the invention, optical system 600 provides a practical and effective system for monitoring of the pipeline 608 at a large number of individually selected positions 611 spaced along a length of the pipeline wherein the positions may be monitored by use of a monitoring device 612 for identifying the location and magnitude of the stress. When excessive stress is detected at a given location, workmen may proceed directly to the indicated location to take appropriate action to relieve the stress.

In some embodiments of the invention, the system 600 relies upon the use of fiber optics in combination with relatively simple and reliable strain monitors 611, for example microbend transducers and/or Bragg gratings. Optical fiber 610 extends along the length of the pipeline 608 through a plurality of strain monitors 611. These strain monitors 611 are physically mounted on the pipeline 608 at selected longitudinally spaced positions for providing response to pipeline stress at a number of discrete locations along the pipeline. The spacing between adjacent strain monitors 611 may vary from less than about 1 meter to about 50 meters or more, for example about 5 to 10 meters, depending upon the determined need for stress monitoring along particular lengths of the pipeline. The number of the strain monitors 611 installed along the fiber 610 may vary from about 2 to about 100 or more, for example from about 5 to 10.

In some embodiments of the invention, strain monitors 611 are designed for actuation by their associated localized portions of the pipeline 608 in response to the presence of pipeline stress and/or strain. When this change occurs, light guided through the fiber 610 is attenuated and/or reflected. The extent of this light change increases with increasing bending amplitude whereby a quantification of the light change provides an indication of the magnitude of pipeline stress and/or strain.

Monitoring of the strain monitors 611 along the length of the optical fiber 610 may be obtained by use of an optical time domain reflectometer at the monitoring station 612. More specifically, as viewed in FIG. 6, this may include light source 612a, for example in the form of a laser or strobe for generating a pulsed light signal of relatively short duration, for example about 50-100 nanoseconds, wherein shorter pulses may be used for higher system resolution and longer pulses may be used for longer lengths of fiber. The pulsed light signal is incident upon the adjacent free end of the optical fiber 610 for passage into and through the optical fiber. Appropriate lens elements (not shown) may be used if desired for focusing the pulsed light signal upon the fiber free end. The light signal may pass from source 612a without substantial attenuation through an angularly oriented optical element such as one-way mirror 612c, or any other suitable optical multiplexing device, into optical fiber 610.

In some embodiments of the invention, optical fiber system 600 may be used for monitoring pipeline strain from a single monitoring station, since the optical time domain reflectometer 612 may monitor the plurality of strain monitors 611. For example, one transducer may not block backscattered light reflected from downstream positions of the fiber. Accordingly, the photodetector 612b may provide an output which may simultaneously indicate the location and magnitude of a second or additional stress acting upon the pipeline.

In some embodiments of the invention, when a new structure 608 is to be monitored, sensors 611 may be “pre-installed,” that is, sensors 611 may be fixed to the structure 608 before installation. This method allows strain sensors 611 to be epoxied or clamped to the structure 608 in the pipe yard or on the deck of the installation vessel. The sensors 611 are then connected to the main optical cable 610, as the structure is being installed, such as in a J-lay or S-lay operation.

In some embodiments of the invention, when an existing structure 608 is to be monitored, the sensors 611 may be “post-installed,” that is, sensors 611 may be fixed to the structure 608 underwater using a remotely operated vehicle (ROV). Several installation methods are suitable. One suitable method allows the sensors 611 to be installed subsea on an existing structure 608 using a “piggyback” concept. The piggyback concept uses clamps, instrumented with strain sensors 611, which are fastened to the structure 608 with an underwater ROV. The clamp provides sufficient force to act as a composite section with the structure 608.

In some embodiments of the invention, an OTDR 612 analyzes back-scattered light. As light passes through the fiber 610, some light is lost by passing outside the fiber or by being reflected in the opposite direction to the movement of light. This backward reflection of light within an optical fiber is called backscatter. As the optical fiber 610 undergoes a strain, a greater proportion of the light is back scattered. This backscatter may be measured and converted to a strain.

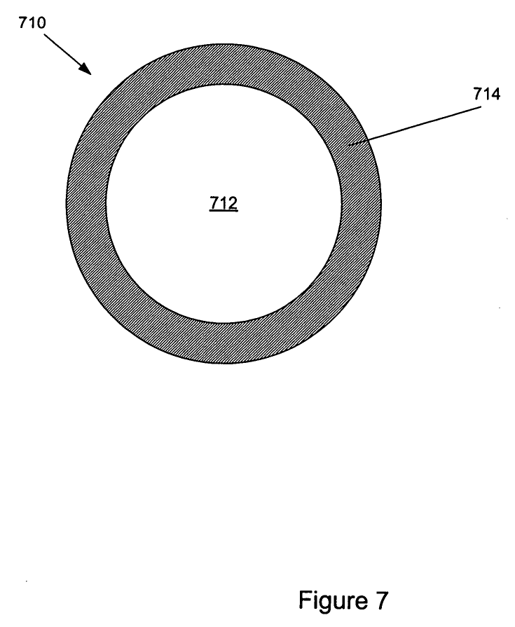

In some embodiments of the invention, referring to FIG. 7, optical fiber 710 is illustrated. Optical fiber 710 includes central core 712 and outer cladding 714. A light signal may be guided through central core 712 of the fiber 710, wherein the core may be encased within outer cladding 714 having an index of refraction less than the refractive index of the core 712. A relatively small portion of this guided or transmitted light may be reflected back to the free end of the fiber as a result of internal imperfections inherent within the optical fiber 610. This reflected portion of the light is referred to as “backscattered light” which has an intensity decreasing along the length of the optical fiber 610. This decreasing backscattered light intensity is reflected angularly off the downstream face of the one-way mirror 612c for incidence upon a photodetector 612b which forms part of the optical time domain reflectometer 612. The light source 612a, one-way mirror 612c, and photodetector 612b are generally known to those skilled in the art.

In operation, for each pulsed light signal, the photodetector 612b may provide an output indicating the backscattered light intensity as a function of time which may be correlated directly with distance along the length of the fiber 610. For example, with reference to FIG. 6, backscattered light reflected from portions of the fiber 610 near the photodetector 612b will be sensed prior to backscattered light reflected from the far end of the fiber 610. Accordingly, time of reflection and longitudinal position along the fiber may be associated directly with each other, whereby the photodetector output is representative of the backscattered light intensity for each longitudinal position along the fiber 610. The intensity of the backscattered light may fall off progressively with increasing distance along the length of the fiber as a result of internal attenuation.

When one of the strain monitors 611 responds to stress acting upon the pipeline 608, a microbend may be induced into the fiber resulting in a loss of a detectable portion of the transmitted and backscattered light at the microbend. More specifically, a portion of the transmitted and backscattered light is scattered from the fiber core 712 into the fiber cladding 714 for escape from the fiber to the surrounding environment. This loss of backscattered light is sensed by the photodetector 612b as a drop in backscattered light intensity at the longitudinal position corresponding with the location of the strain monitor 611. This intensity attenuation along the length of the fiber where the magnitude of the attenuation may correspond with the magnitude of the pipeline strain, whereby the output of the photodetector 612b may be scaled to provide a direct reading of strain magnitude.

In some embodiments of the invention, the sensitivity and accuracy of the photodetector 612b output may be improved by the provision of means for stripping from the fiber cladding 714 all light that is scattered to the cladding 714 as a result of microbending of the fiber. This stripping means, or mode stripper, is positioned directly at the microbend of each microbend transducer for immediate stripping of this light in order to prevent propagation of the light along the cladding where it is subject to partial reflection or transmission back into the fiber core 712. One suitable refracting substance comprises liquid glycerin which does not restrain bending movement of the fiber but which has a sufficient viscosity. The refracting substance may have an optically irregular exterior surface configuration whereby the light transmitted into the substance tends to be absorbed and lost without reflection back into the fiber cladding 714. Alternatively, the mode stripper may be provided in the form of an optically black surface coating formed directly on the fiber 610 at the microbend. With this arrangement, the optically black coating surface absorbs the light immediately from the fiber cladding 714 to prevent retransmission of light from the cladding back into the fiber core 712.

Suitable systems for monitoring properties of a structure are disclosed in United States Patent Application Publication No. 2004/0206187, United States Patent Application Publication No. 2004/0035216, U.S. Pat. No. 6,784,983, U.S. Pat. No. 5,026,141, U.S. Pat. No. 4,654,520, U.S. Pat. No. 4,463,254, PCT International Published Application WO 97/36150, and European Patent Office Publication Number 0 278 143 B1, which are herein incorporated by reference in their entirety.

Those of skill in the art will appreciate that many modifications and variations are possible in terms of the disclosed embodiments, configurations, materials and methods without departing from their spirit and scope. Accordingly, the scope of the claims appended hereafter and their functional equivalents should not be limited by particular embodiments described and illustrated herein, as these are merely exemplary in nature.

What is claimed:

1. A system for remotely detecting properties of an underwater structure in a body of water comprising:
a sensor connectable to the structure;
a first receiver which can be positioned at or near a top surface of the body of water in the proximity of the structure;
a first transmitter for transmitting property information from the sensor to the first receiver; and
a second transmitter for transmitting the property information from the first receiver to a second receiver which can be located at a remote location.

2. The system of claim 1, wherein the sensor comprises a fiber optic cable.

3. The system of claim 1, further comprising an umbilical adapted connect at least one of the first transmitter and the sensor to the first receiver.

4. The system of claim 1, wherein the first receiver can be positioned on a floating object, for example a buoy or a boat.

5. The system of claim 1, wherein the second transmitter comprises a device adapted to transmit a signal in the electromagnetic spectrum, such as a radio frequency transmitter and an antenna; a large visible display which can be read from the remote location; a light source which can be modulated, such as to transmit morse code; a microwave transmitter; and a laser modulation device.

6. The system of claim 1, wherein the sensor comprises a fiber optic cable and a plurality of bragg gratings.

7. The system of claim 1, wherein the sensor comprises a fiber optic cable and plurality of microbend transducers.

8. The system of claim 1, wherein the underwater structure comprises a pipeline, a piling, or a foundation.

9. The system of claim 1, wherein the remote location comprises an offshore platform.

10. The system of claim 1, wherein the sensor comprises a fiber optic cable, the fiber optic cable being connectable to a light source, a light receptor, and a processor for processing the information.

11. The system of claim 1, wherein the sensor comprises:
a first fiber optic cable attachable to the structure;
a second fiber optic cable capable of acting as a reference;
a light source which can be placed at a first end of the first fiber optic cable and at a first end of the second fiber optic cable;
a light receptor which can be placed at a second end of the first fiber optic cable and at a second end of the second fiber optic cable; and
a comparator for comparing the light signals which can be received from the first and second fiber optic cables.

12. A method of remotely detecting properties of an underwater structure comprising:
collecting property information at a sensor connected to the structure;
transmitting the information from the sensor to a first receiver at or near a top surface of a body of water; and
transmitting the information from the first receiver to a second receiver positioned at a remote location.

13. The method of claim 12, wherein the sensor comprises a fiber optic cable.

14. The method of claim 12, wherein transmitting the information from the sensor to the first receiver comprises transmitting by an umbilical.

15. The method of claim 12, wherein the sensor is connected to the structure before the structure is installed underwater.

16. The method of claim 12, wherein transmitting the information from the first receiver to the remote location comprises feeding the information to a radio frequency transmitter located at or near a top surface of a body of water, which radio frequency transmitter broadcasts the information with an antenna.

17. The method of claim 12, wherein collecting property information at the sensor comprises bending a fiber optic cable with a plurality of bragg gratings, and measuring a response to the bending.

18. The method of claim 12, wherein collecting property information at the sensor comprises measuring the output from a plurality of microbend transducers.

19. The method of claim 12, wherein the sensor comprises a fiber optic cable, a light source, a light receptor, and a processor, the method further comprising:
sending a light signal into the fiber optic cable from the light source;
receiving a modified light signal from the fiber optic cable to the light receptor; and
processing the modified light signal with the processor.

20. The method of claim 12, wherein the sensor comprises:
a first fiber optic cable attached to the structure and a second fiber optic cable acting as a reference, a light receptor, a processor, and a comparator, the method further comprising:
sending light signals into the first and second fiber optic cables at a first end of the first fiber optic cable and a first end of the second fiber optic cable;
receiving the modified light signals from the first and second fiber optic cables at the light receptor at a second end of the first fiber optic cables and at a second end of the second fiber optic cables;
processing the modified light signals with a processor; and
comparing the modified light signals received from the first and second fiber optic cables with a comparator.
